(19) United States
(12) Patent Application Publication
(10) Pub. No.: US 2017/0371191 A1
(43) Pub. Date: Dec. 28, 2017

(54) LIQUID CRYSTAL DISPLAY PANEL AND LIQUID CRYSTAL DISPLAY APPARATUS

(71) Applicant: WUHAN CHINA STAR OPTOELECTRONICS TECHNOLOGY CO., LTD., Wuhan, Hubei (CN)

(72) Inventor: Xinhui ZHONG, Wuhan, Hubei (CN)

(21) Appl. No.: 15/113,569

(22) PCT Filed: Apr. 5, 2016
(86) PCT No.: PCT/CN2016/078425

§ 371 Date: Jul. 22, 2016

(30) Foreign Application Priority Data
Mar. 11, 2016 (CN) 201610139422.6

(51) Int. Cl. G02F 1/13363; G02F 1/1335; G02F 1/1343

(52) U.S. Cl. CPC G02F 1/13363; G02F 1/134309; G02F 1/133514; G02F 1/133528; G02F 1/133553; G02F 1/133512; G02F 1/1336; G02F 2001/133531; G02F 2001/133616; G02F 2001/133618; G02F 2001/133638

(57) ABSTRACT

A liquid crystal display panel and a liquid crystal display apparatus are provided. The liquid crystal display panel includes a first substrate, a liquid crystal layer between the first substrate and a second substrate, and the second substrate disposed opposite to the first substrate. The second substrate includes a second base, a lower polarizing film positioned under the second base; and a wave plate positioned under the lower polarizing film, and used to reduce ambient light reflected by a reflection film.

### FIELD OF THE INVENTION

The present invention relates to the technical field of a display, and particularly to a liquid crystal display panel and a liquid crystal display apparatus.

### BACKGROUND OF THE INVENTION

With the continuing development of liquid crystal displays (LCD), the contrast, the brightness, the color gamut, and other characteristics of liquid crystal displays are correspondingly improved. In most cases, the existing liquid crystal displays have been able to meet people's demand for information display.

However, in the outdoor environment under intense light, due to the influence of ambient light, the display characteristics of the liquid crystal displays will deteriorate, causing the users to have difficulty in clearly seeing the content on the screen. Nevertheless, the devices often used in daily life, such as cell phones, watches and other wearable devices, as well as outdoor equipment and facilities, are inevitably used in the outdoor environment under intense light. When the liquid crystal display is in the dark state, the liquid crystal display has a very low penetration, and at this time, the backlight is blocked by the liquid crystal display, and the ambient light can not penetrate the panel to reach the reflection film. Thus, the display effect is not affected.

However, when the liquid crystal display is in the bright state, the backlight can reach the eyes through the liquid crystal display and the intense ambient light can reach the reflection film through the panel and be reflected into the eyes. Therefore, when the ambient light is intense, the display effect of the liquid crystal display is affected, making it difficult for the users to clearly see the content on the screen, resulting in a poor display effect.

Therefore, it is necessary to provide a liquid crystal panel and a liquid crystal apparatus to solve the problem in the conventional technique.

### SUMMARY OF THE INVENTION

A primary object of the present invention is to provide a liquid crystal display panel and a liquid crystal display apparatus for resolving the technical problem of the poor display effect of the liquid crystal display panel and the liquid crystal display apparatus in the conventional technique used in the outdoor environment under intense light.

To achieve the above object, the present invention provides a liquid crystal display panel, comprising:
a first substrate including:
   a first base; and
   an upper polarizing film positioned on the first base;
a liquid crystal layer between the first substrate and a second substrate; and
the second substrate disposed opposite to the first substrate, the second substrate including:
   a second base;
   a lower polarizing film positioned under the second base; and
   a wave plate positioned under the lower polarizing film, and used to reduce ambient light reflected by a reflection film, the wave plate being a quarter wave plate, a half wave plate, or a combination of the quarter wave plate and the half wave plate, wherein an angle between a direction of an absorption axis of the lower polarizing plate and a direction of a fast axis of the wave plate is 45 degrees or 135 degrees.

In the liquid crystal display panel of the present invention, the first substrate is a color filter substrate, and the second substrate is an array substrate.

In the liquid crystal display panel of the present invention, the first substrate further includes a black matrix layer, a color resist layer, and a transparent conductive layer.

In the liquid crystal display panel of the present invention, a material of the upper polarizing film and the lower polarizing film is polyvinyl alcohol.

To achieve the above object, the present invention provides a liquid crystal display panel, comprising:
a first substrate including:
   a first base; and
   an upper polarizing film positioned on the first base;
a liquid crystal layer between the first substrate and a second substrate; and
the second substrate disposed opposite to the first substrate, the second substrate including:
   a second base;
   a lower polarizing film positioned under the second base; and
   a wave plate positioned under the lower polarizing film, and used to reduce ambient light reflected by a reflection film.

In the liquid crystal display panel of the present invention, the wave plate is a quarter wave plate, a half wave plate, or a combination of the quarter wave plate and the half wave plate.

In the liquid crystal display panel of the present invention, an angle between a direction of an absorption axis of the lower polarizing plate and a direction of a fast axis of the wave plate is 45 degrees or 135 degrees.

In the liquid crystal display panel of the present invention, the first substrate is a color filter substrate, and the second substrate is an array substrate.

In the liquid crystal display panel of the present invention, a material of the upper polarizing film and the lower polarizing film is polyvinyl alcohol.

To achieve the above object, the present invention provides a liquid crystal display apparatus, comprising:
a backlight module including a reflection film; and
a liquid crystal display panel including:
   a first substrate including:
      a first base; and
      an upper polarizing film positioned on the first base;
   a liquid crystal layer between the first substrate and a second substrate; and
   the second substrate disposed opposite to the first substrate, the second substrate including:
      a second base;
      a lower polarizing film positioned under the second base; and
      a wave plate positioned under the lower polarizing film, and used to reduce ambient light reflected by the reflection film.

In the liquid crystal display apparatus of the present invention, the wave plate is a quarter wave plate, a half wave plate, or a combination of the quarter wave plate and the half wave plate.

In the liquid crystal display apparatus of the present invention, an angle between a direction of an absorption axis of the lower polarizing plate and a direction of a fast axis of the wave plate is 45 degrees or 135 degrees.

In the liquid crystal display apparatus of the present invention, the first substrate is a color filter substrate, and the second substrate is an array substrate.

In the liquid crystal display apparatus of the present invention, a material of the upper polarizing film and the lower polarizing film is polyvinyl alcohol.

By disposing the wave plate under the lower polarizing film of the conventional panel, the liquid crystal display panel and the liquid crystal display apparatus of the present invention prevent ambient light from entering the panel and being reflected by the reflection film and enhance the display effect, especially in an outdoor environment under intense light.

### BRIEF DESCRIPTION OF THE DRAWINGS

FIG. 1 is a schematic structure of a liquid crystal panel of the present invention; and

FIG. 2 is a schematic structure of the optical path principle of a liquid crystal panel of the present invention.

### DETAILED DESCRIPTION OF THE PREFERRED EMBODIMENTS

The following description of the embodiments with reference to the accompanying drawings is used to illustrate particular embodiments of the present invention. The directional terms referred in the present invention, such as “upper”, “lower”, “front”, “back”, “left”, “right”, “inner”, “outer”, “side surface”, etc. are only directions with regard to the accompanying drawings. Therefore, the directional terms used for describing and illustrating the present invention are not intended to limit the present invention.

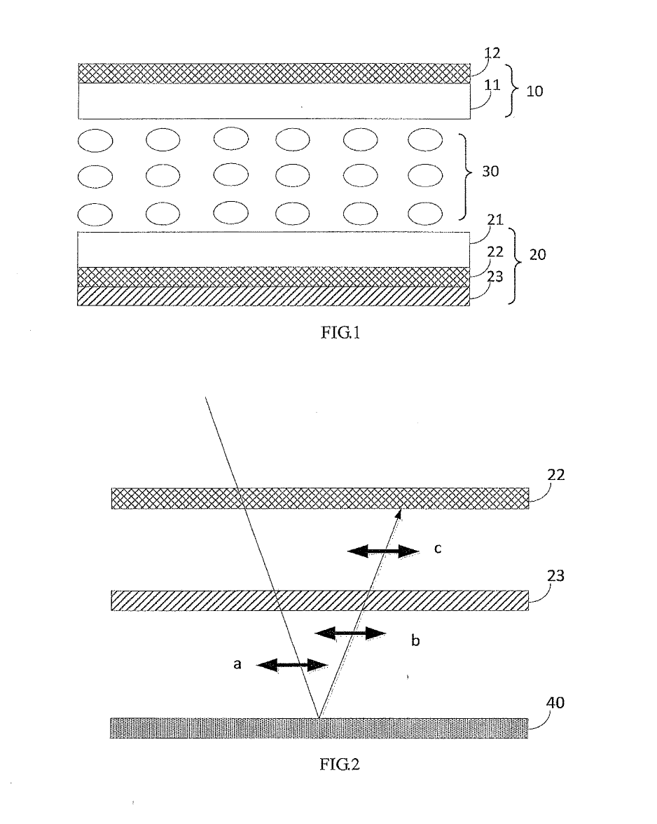

Please refer to FIG. 1, which is a schematic structure of a liquid crystal panel of the present invention.

As shown in FIG. 1, the liquid crystal display panel of the present invention includes a first substrate 10, a second substrate 20, and a liquid crystal layer 30. The first substrate 10 includes a first base 11 and an upper polarizing film 12 positioned on the first base. The liquid crystal layer 30 is positioned between the first substrate 10 and the second substrate 20. The second substrate 20 is disposed opposite to the first substrate 10.

The second substrate 20 includes a second base 21, a lower polarizing film 22, and a wave plate 23. The lower polarizing film 22 is positioned under the second base 21, and the wave plate 23 is positioned under the lower polarizing film 22. The wave plate 23 is used to reduce ambient light reflected by a reflection film

As shown in FIG. 2, when the ambient light is emitted through the lower polarizing film 22 to the wave plate 23, the wave plate 23 turns the ambient light into circularly polarized light “a”. After reflected by the reflection film 40, the circularly polarized light “a” is present as reverse direction circularly polarized light “b”. After passing through the wave plate 23, the reverse direction circularly polarized light “b” is turned into circularly polarized light “c”. Since the angle of the circularly polarized light “c” is perpendicular to the absorption axis of the lower polarizing film 22, the polarized light cannot reach the eyes through the lower polarizing film after being processed by the wave plate 23, thereby eliminating the influence of the intense ambient light on the display effect of the display panel, and enhancing the display effect.

Furthermore, since the ambient light enters the backlight module, the ambient light can be used as backlight, which reduces the power consumption of backlight, and improves the utilization of the ambient light.

Preferably, the wave plate 23 is a quarter wave plate, a half wave plate, or a combination of a quarter wave plate and a half wave plate.

In order to prevent the ambient light from being reflected by the reflection film to enter the eye, the angle between the direction of the absorption axis of the lower polarizing plate 22 and the direction of the fast axis of the wave plate 23 is 45 degrees or 135 degrees. If the angle is too large or too small, the angle between the linear polarized light processed by the reflection film and the absorption axis of the lower polarizing plate cannot be 90 degrees. Therefore, when the above requirement is met, the ambient light which enters the panel and is reflected by the reflection film can be more effectively prevented from entering the eyes.

The first substrate 10 may be a color filter substrate, and the second substrate 20 may be an array substrate. When it is an array substrate, the second substrate 20 may include multiple data lines and multiple scan lines, as well as the multiple pixel units defined by the multiple data lines and the multiple scan lines. When it is a color filter substrate, the first substrate 10 may include a black matrix layer, a color resist layer, and a transparent conductive layer.

Preferably, the material of the upper polarizing film and the lower polarizing film is polyvinyl alcohol.

Since the wave plate is disposed under the lower polarizing film, the liquid crystal display panel of the present invention prevents ambient light from entering the panel and being reflected by the reflection film, and enhances the display effect.

The present invention also provides a liquid crystal display apparatus including a backlight module and a liquid crystal display panel. The backlight module includes a reflection film, As shown in FIG. 1, the liquid crystal display panel includes a first substrate 10, a second substrate 20, and a liquid crystal layer 30. The first substrate 10 includes a first base 11 and an upper polarizing film 12 positioned on the first base. The liquid crystal layer 30 is positioned between the first substrate 10 and the second substrate 20. The second substrate 20 is disposed opposite to the first substrate 10.

The second substrate 20 includes a second base 21, a lower polarizing film 22, and a wave plate 23. The lower polarizing film 22 is positioned under the second base 21, and the wave plate 23 is positioned under the lower polarizing film 22. The wave plate 23 is used to reduce ambient light reflected by a reflection film

As shown in FIG. 2, when the ambient light is incident from the lower polarizing film 22 to the wave plate 23, the wave plate 23 turns the ambient light into circularly polarized light “a”. After reflected by the reflection film 40, the circularly polarized light “a” is present as reverse direction circularly polarized light “b”. After passing through the wave plate 23, the reverse direction circularly polarized light “b” is turned into circularly polarized light “c”. Since the angle of the circularly polarized light “c” is perpendicular to the absorption axis of the lower polarizing film 22, the polarized light cannot reach the eyes through the lower polarizing film after being processed by the wave plate 23, thereby eliminating the influence of the intense ambient light on the display effect of the display panel, and enhancing the display effect.

Furthermore, since the ambient light enters the backlight module, the ambient light can be used as backlight, which reduces the power consumption of backlight, and improves the utilization of the ambient light.

Preferably, the wave plate 23 is a quarter wave plate, a half wave plate, or a combination of a quarter wave plate and a half wave plate.

In order to prevent the ambient light from being reflected by the reflection film to enter the eye, the angle between the direction of the absorption axis of the lower polarizing plate 22 and the direction of the fast axis of the wave plate 23 is 45 degrees or 135 degrees. If the angle is too large or too small, the angle between the linear polarized light processed by the reflection film and the absorption axis of the lower polarizing plate cannot be 90 degrees.

Therefore, when the above requirement is met, the ambient light which enters the panel and is reflected by the reflection film can be more effectively prevented from entering the eyes.

The first substrate 10 may be a color filter substrate, and the second substrate 20 may be an array substrate. When it is an array substrate, the second substrate 20 may include multiple data lines and multiple scan lines, as well as the multiple pixel units defined by the multiple data lines and the multiple scan lines. When it is a color filter substrate, the first substrate 10 may include a black matrix layer, a color resist layer, and a transparent conductive layer.

Preferably, the material of the upper polarizing film and the lower polarizing film is polyvinyl alcohol.

Since the wave plate is disposed under the lower polarizing film, the liquid crystal display panel of the present invention prevents ambient light from entering the panel and being reflected by the reflection film, and enhances the display effect.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

What is claimed is:

1. A liquid crystal display panel, comprising:
a first substrate including:
a first base; and
an upper polarizing film positioned on the first base;
a liquid crystal layer between the first substrate and a second substrate; and
the second substrate disposed opposite to the first substrate, the second substrate including:
a second base;
a lower polarizing film positioned under the second base; and
a wave plate positioned under the lower polarizing film, and used to reduce ambient light reflected by a reflection film, the wave plate being a quarter wave plate, a half wave plate, or a combination of the quarter wave plate and the half wave plate, wherein an angle between a direction of an absorption axis of the lower polarizing plate and a direction of a fast axis of the wave plate is 45 degrees or 135 degrees.

2. The liquid crystal display panel as claimed in claim 1, wherein the first substrate is a color filter substrate, and the second substrate is an array substrate.

3. The liquid crystal display panel as claimed in claim 2, wherein the first substrate further includes a black matrix layer, a color resist layer, and a transparent conductive layer.

4. The liquid crystal display panel as claimed in claim 2, wherein a material of the upper polarizing film and the lower polarizing film is polyvinyl alcohol.

5. A liquid crystal display panel, comprising:
a first substrate including:
a first base; and
an upper polarizing film positioned on the first base;
a liquid crystal layer between the first substrate and a second substrate; and
the second substrate disposed opposite to the first substrate, the second substrate including:
a second base;
a lower polarizing film positioned under the second base; and
a wave plate positioned under the lower polarizing film, and used to reduce ambient light reflected by a reflection film.

6. The liquid crystal display panel as claimed in claim 5, wherein the wave plate is a quarter wave plate, a half wave plate, or a combination of the quarter wave plate and the half wave plate.

7. The liquid crystal display panel as claimed in claim 5, wherein an angle between a direction of an absorption axis of the lower polarizing plate and a direction of a fast axis of the wave plate is 45 degrees or 135 degrees.

8. The liquid crystal display panel as claimed in claim 5, wherein the first substrate is a color filter substrate, and the second substrate is an array substrate.

9. The liquid crystal display panel as claimed in claim 5, wherein a material of the upper polarizing film and the lower polarizing film is polyvinyl alcohol.

10. A liquid crystal display apparatus, comprising:
a backlight module including a reflection film; and
a liquid crystal display panel, including:
a first substrate including:
a first base; and
an upper polarizing film positioned on the first base;
a liquid crystal layer between the first substrate and a second substrate; and
the second substrate disposed opposite to the first substrate, the second substrate including:
a second base;
a lower polarizing film positioned under the second base; and
a wave plate positioned under the lower polarizing film, and used to reduce ambient light reflected by the reflection film.

11. The liquid crystal display apparatus as claimed in claim 10, wherein the wave plate is a quarter wave plate, a half wave plate, or a combination of the quarter wave plate and the half wave plate.

12. The liquid crystal display apparatus as claimed in claim 10, wherein an angle between a direction of an absorption axis of the lower polarizing plate and a direction of a fast axis of the wave plate is 45 degrees or 135 degrees.

13. The liquid crystal display apparatus as claimed in claim 10, wherein the first substrate is a color filter substrate, and the second substrate is an array substrate.

14. The liquid crystal display apparatus as claimed in claim 10, wherein a material of the upper polarizing film and the lower polarizing film is polyvinyl alcohol.
